(19) United States
(12) Patent Application Publication
(10) Pub. No.: US 2017/0166062 A1
(43) Pub. Date: Jun. 15, 2017

(54) BRAKING SYSTEM OF A HEAVY-DUTY VEHICLE

(71) Applicant: Proterra Inc., Greenville, SC (US)

(72) Inventors: MATTHEW SIMONINI, Greenville, SC (US); SAMUEL SHARTZER, Greenville, SC (US)

(73) Assignee: Proterra Inc., Greenville, SC (US)

(21) Appl. No.: 14/964,860

(22) Filed: Dec. 10, 2015

(51) Int. Cl. B60L 7/26; B60T 7/04

(52) U.S. Cl. CPC B60L 7/26; B60T 7/042

(57) ABSTRACT

A heavy-duty electric vehicle having a pneumatic brake may include at least one electric motor configured to propel the vehicle, and a battery system configured to provide power to the at least one electric motor. The battery system may be configured to be recharged by regenerative braking of the vehicle. The vehicle may also include a braking system. The braking system may be configured to (a) apply substantially only regenerative braking to slow the vehicle during initial slowdown and (b) subsequently apply both regenerative braking and pneumatic braking after the initial slowdown.

### TECHNICAL FIELD

The current disclosure relates to systems and methods for controlling the braking system of a heavy duty vehicle.

### BACKGROUND

The United States Environmental Protection Agency (EPA) defines heavy-duty vehicles as vehicles having a gross vehicle weight exceeding 8500 lbs. Such vehicles include, for example, trucks, buses, and other large commercial or industrial vehicles. Heavy-duty vehicles typically include an air (or pneumatic) brake system in which air pressure on a piston is used to press brake pads against the wheels to stop the vehicle. In such a braking system, the kinetic energy of the vehicle is converted into heat by friction (friction braking). Studies have shown that in urban driving about one third to one half of the energy required for operation of a vehicle is consumed in braking.

Heavy-duty electric vehicles also include a regenerative braking system in addition to the friction braking system. In this disclosure, the term electric vehicle is used to refer to both electric and hybrid vehicles. Regenerative braking slows the vehicle by using its electric motor as a generator to produce energy and provide a braking effect. During regenerative braking, kinetic energy of the vehicle is converted to electrical energy. The recovered energy may be used to recharge the battery of the vehicle. During operation of the electric vehicle, both its friction and regenerative braking systems are used to slow the vehicle. Typically, when the driver steps on the brake pedal, different proportions of friction and regenerative braking act to slow the vehicle based on the brake pedal position. Effective control of the braking system can improve the energy efficiency of the electric vehicle while providing the required deceleration. The current disclosure describes systems and methods to effectively control the braking system of a heavy-duty vehicle. The scope of the current disclosure, however, is defined by the attached claims, and not by its ability to solve a specific problem or provide any particular improvement.

### SUMMARY

Embodiments of the present disclosure relate to, among other things, systems and methods for controlling the braking system of a heavy-duty vehicle. Each of the embodiments disclosed herein may include one or more of the features described in connection with any of the other disclosed embodiments.

In one embodiment, a heavy-duty electric vehicle having a pneumatic brake is disclosed. The vehicle may include at least one electric motor configured to propel the vehicle, and a battery system configured to provide power to the at least one electric motor. The battery system may be configured to be recharged by regenerative braking of the vehicle. The vehicle may also include a braking system. The braking system may be configured to (a) apply substantially only regenerative braking to slow the vehicle during initial slowdown and (b) subsequently apply both regenerative braking and pneumatic braking after the initial slowdown.

In another embodiment, a method of controlling the braking of a heavy-duty electric vehicle is disclosed. The method may include directing air at a first pressure indicative of a brake pedal position to a braking system of the vehicle. The method may also include controlling the braking system to (a) apply substantially only regenerative braking to slow the vehicle during initial slowdown and (b) subsequently apply both regenerative braking and pneumatic braking after the initial slowdown.

In yet another embodiment, a method of slowing a heavy-duty electric bus using a combination of pneumatic braking and regenerative braking is disclosed. The method may include pressing a brake pedal of the bus from a brake pedal position of zero percent of maximum brake pedal deflection to a higher value to slow the bus. The method may also include applying substantially only regenerative braking to slow the bus during the pressing until the brake pedal is pressed to a predetermined percent of the maximum brake pedal deflection, and applying both regenerative braking and pneumatic braking to slow the bus when the brake pedal is pressed by more than the predetermined percent.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIGS. 1A and 1B are schematic illustrations of an exemplary low-floor electric bus;

FIG. 2 is a schematic of an exemplary braking system of the bus of FIG. 1;

FIG. 3 is a graph illustrating the relationship between input and output air pressures in the braking system of FIG. 2 in an exemplary embodiment; and

FIG. 4 is another graph illustrating the relationship between input and output air pressures in the braking system of FIG. 2 in other exemplary embodiments.

### DETAILED DESCRIPTION

The present disclosure describes systems and methods for controlling the braking system of a heavy-duty electric vehicle. In the discussion below, the principles of the current disclosure are described with reference to a low-floor electric bus. However, it should be understood that the disclosure is not limited thereto. Rather, the systems and methods of the present disclosure may be used to control the braking system of any electric vehicle having a pneumatic braking system.

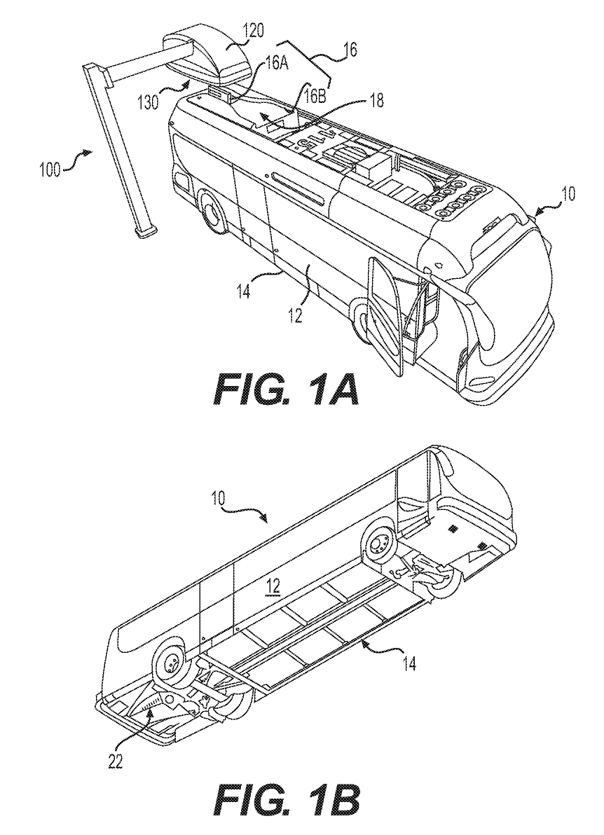

FIGS. 1A and 1B illustrate an electric vehicle in the form of an electric bus 10. FIG. 1A shows the top perspective view of the bus 10 and FIG. 1B shows its bottom view. In the discussion that follows, reference will be made to both FIGS. 1A and 1B. Electric bus 10 may include a body 12 enclosing a space for passengers. In some embodiments, some (or substantially all) parts of the body 12 may be fabricated using composite materials to reduce the weight of bus 10. As is known in the art, in a low-floor bus, there are no stairs at the front and/or the back doors of the bus. In such a bus, the floor is positioned close to the road surface to ease entry and exit into the bus. In some embodiments, the floor height of the low-floor bus may be about 12-16 inches (30-40 centimeters) from the road surface. Body 12 of bus 10 may have any size, shape, and configuration.

Bus 10 may include one or more electric motors 22 that generates power for propulsion and a battery system 14 that provides power to the electric motors 22. In some embodiments, individual motors 22 may be coupled to each wheel while in other embodiments, a single motor 22 may operate multiple wheels. In some embodiments, as illustrated in FIG. 1B, the battery system 14 may be positioned under the floor of the bus 10. The battery system 14 may have a modular structure and may be configured as a plurality of battery packs, each including a plurality of battery modules with multiple battery cells. In some embodiments, the battery packs may be positioned in cavities located under the floor of the bus 10.

The batteries of battery system 14 may have any chemistry and construction. In some embodiments, the batteries may be lithium titanate oxide (LTO) batteries. In some embodiments, the batteries may be nickel manganese cobalt (NMC) batteries. LTO batteries may be fast charge batteries that may allow the bus 10 be recharged to substantially its full capacity in a small amount of time (e.g., about ten minutes or less). In this disclosure, the terms “about,” “substantially,” or “approximate” are used to indicate a potential variation of 10% of a stated value. Due to its higher charge density, NMC batteries may take longer to charge to a comparable state of charge (SOC), but NMC batteries may retain a larger amount of charge and thus increase the range of the bus 10. It is also contemplated that, in some embodiments, the batteries may include other or multiple different chemistries. For instance, some of the batteries may be LTO or NMC batteries, while other batteries may have another chemistry (for example, iron-phosphate, lead-acid, nickel cadmium, nickel metal hydride, lithium ion, zinc air, etc.). Some of the possible battery chemistries and arrangements in bus 10 are described in commonly assigned U.S. Pat. No. 8,453,773, which is incorporated herein by reference in its entirety.

Although the battery system 14 is illustrated and described as being positioned under the floor of the bus 10, this is only exemplary. In some embodiments, some or all of the batteries in the battery system 14 may be positioned elsewhere on the bus 10. For example, some of the battery packs may be positioned on the roof of bus 10. As the battery system 14 may have considerable weight, integrating the battery system into the floor of a bus 10 may keep the center of gravity lower and balance weight distribution, thus increasing drivability and safety.

A charging interface 16 may be provided on the roof 18 of the bus 10 to charge the batteries of the battery system 14. The charging interface 16 may include a charging blade 16A and an alignment scoop 16B. The charging blade 16A may include electrodes that are electrically coupled to the battery system 14. The alignment scoop 16B may include a pair of curved rails, positioned on either side of the charging blade 16B, that forms a funnel-shaped alignment feature. The charging interface 16 may engage with a charge head 130 (which is within a charge head assembly 120) of an external charging station 100 to charge the battery system 14. The charging station 100 may be provided at any location (bus depot, road side, etc.) and may be powered by an electric utility grid.

To charge the bus 10, the bus 10 may be positioned under the overhanging charge head assembly 120 of the charging station 100. When the bus 10 is thus positioned, the charge head 130 may descend from the charge head assembly 120 to land on the roof 18 of the bus 10. With the charge head 130 resting on the roof 18, the bus 10 may be moved forward to engage the charge head 130 with the charging blade 16A. As the charge head 130 slides on the roof 18 towards the charging blade 16A, the funnel-shaped alignment scoop 16B may align and direct the charge head 130 towards the charging blade 16A. Details of the charge head 130 and the interfacing of the charge head 130 with the charging interface 16 are described in commonly assigned U.S. Patent Application Publication Nos. US 2013/0193918 A1 and US 2014/0070767 A1, which are incorporated by reference in their entirety herein. Alternatively or additionally, bus 10 may also include an on-board charging device to charge the battery system 14. The on-board charging device may include an auxiliary power generation device (such as, an internal combustion engine or a fuel cell positioned, for example, on the roof) that generates power to charge the battery system 14.

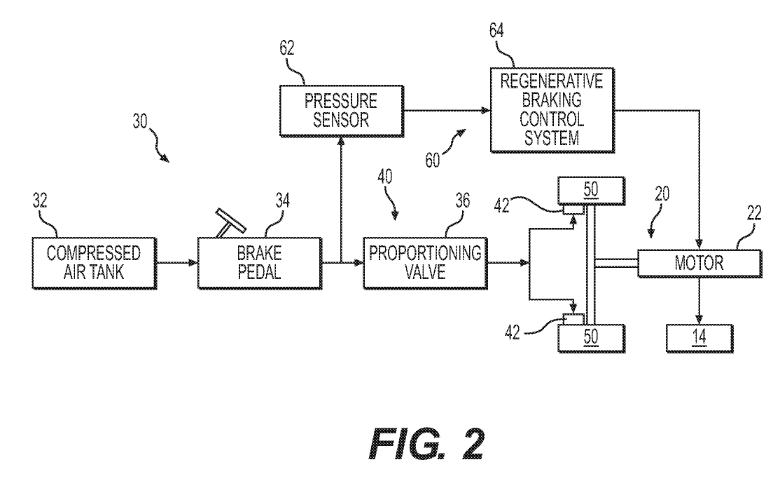

Bus 10 may include multiple operating systems that work together during operation of the bus 10. FIG. 2 is a simplified schematic illustration of some exemplary operating systems of the bus 10. It should be noted that, for simplicity, FIG. 2 only illustrates components/systems of the bus 10 that are helpful in describing the current disclosure. With reference to FIG. 2, bus 10 may include a power train 20 that provides power to propel the bus 10, and a braking system 30 configured to slow (and finally stop) the bus 10 when the driver steps, or presses down, on a brake pedal 34. The braking system 30 includes a pneumatic (or air) braking system 40 and a regenerative braking system 60 that work together to slow the bus 10 in response to the position of the brake pedal 34. The pneumatic braking system 40 includes a compressed air tank 32 fluidly connected to air cylinders 42 associated with the wheels 50 of the bus 10. Although FIG. 2 only illustrates the braking system associated with two of the wheels of the bus 10, the other two wheels may also have a similar braking system.

Filtered air, compressed by an air compressor (not shown) of the bus 10, is stored in the air tank 32. Compressed air from the air tank 32 is directed to the air cylinders 42 through the brake pedal 34 and a proportioning valve 36. The pressure of the air directed to the air cylinders 42 may vary as a function of the brake pedal 34 position. In response to the air pressure, the air cylinders 42 may press brake calipers (or brake pads) against brake disks (or rotors or brake drums) on the wheels 50 to slow the bus 10 by friction braking. In addition to friction braking, a regenerative braking control system 64 may detect the position of the brake pedal 34 and control the motor 22 to operate as a generator to apply a negative torque on the drive line and thereby retard the bus 10 by regenerative braking. That is, in response to the position of the brake pedal 34, a retarding force may be applied to slow the bus 10 using both friction and regenerative braking.

The brake pedal 34, positioned in the operator cabin of the bus 10, may be a conventional brake pedal used in air brake systems. When the driver steps on, or presses, the brake pedal 34, the air pressure downstream of the pedal 34 increases. In some embodiments, the brake pedal 34 acts as a mechanical pressure regulator to vary the downstream of the brake pedal. However, it is also contemplated that in some embodiments, the brake pedal position may merely indicate a value of air pressure downstream if the brake pedal 34. This air pressure may be indicative of the brake pedal 34 position. The proportioning valve 36 may be selectively activated and deactivated based on the input air pressure (Pᵢₙ) from the brake pedal 34. In some embodiments, the proportioning valve 36 may be activated and deactivated by a signal pressure (that is indicative of Pᵢₙ) from the control system 64. In the deactivated state, the proportioning valve 36 may be act as though it is decoupled from the system, and the pressure downstream of proportioning valve 36 may be same as the upstream pressure (i.e., Pᵢₙ). That is, when deactivated, the pressure upstream and downstream of the proportioning valve 36 may be Pᵢₙ. When activated, the proportioning valve 36 may vary the output air pressure (Pₒᵤₜ) based on the input air pressure Pᵢₙ. In some embodiments, when activated, Pₒᵤₜ may be less than Pᵢₙ. The amount by which Pₒᵤₜ is lower than Pᵢₙ may depend on the input pressure Pᵢₙ.

Proportioning valve 36 may include valves and other flow control mechanisms to vary the output air pressure (Pₒᵤₜ) profile based on the input air pressure (Pᵢₙ) profile. Since methods of designing pneumatic valves to produce a desired output pressure profile are known in the art, it is not discussed herein. Any type of valve may be used as a proportioning valve 36. In some embodiments, a commercially available bobtail proportioning valve (such as, for example, from Bendix Commercial Vehicle Systems LLC) may be used as proportioning valve 36. In response to the output air pressure (Pₒᵤₜ) from the proportioning valve 36, the air cylinders 42 may activate calipers/brake pads and retard the bus by friction braking. The retarding force produced by friction braking may be a function of the output air pressure (Pₒᵤₜ).

The regenerative braking control system 64 may detect the brake pedal 34 position based on readings from a pressure sensor 62 and may apply regenerative braking to supplement the friction braking. Although the regenerative braking control system 64 is described and illustrated as a single control system, in some embodiments, multiple controllers of the bus 10 may perform the functions of the regenerative braking control system 64. Based on the brake pedal position, the control system 64 may control the motor 22 to function in a generator mode to apply a retarding force to slow the bus 10 and produce electric current in the process. Operating the motor 22 in a generator mode may be akin to instructing the motor 22 to produce a negative torque to slow the bus. The energy produced during regenerative braking may be stored in the battery system 14 or may be used to power auxiliary systems (internal lights, etc.) of the bus 10. The amount of regenerative braking applied corresponding to different brake pedal positions is determined by the control system 64. In some embodiments, a map (e.g., a table of values, etc.) stored in the control system 64 (or an equation/algorithm programmed in the control system 64) may indicate the amount of regenerative braking applied (or the amount of negative torque applied) for different brake pedal positions (or Pᵢₙ values).

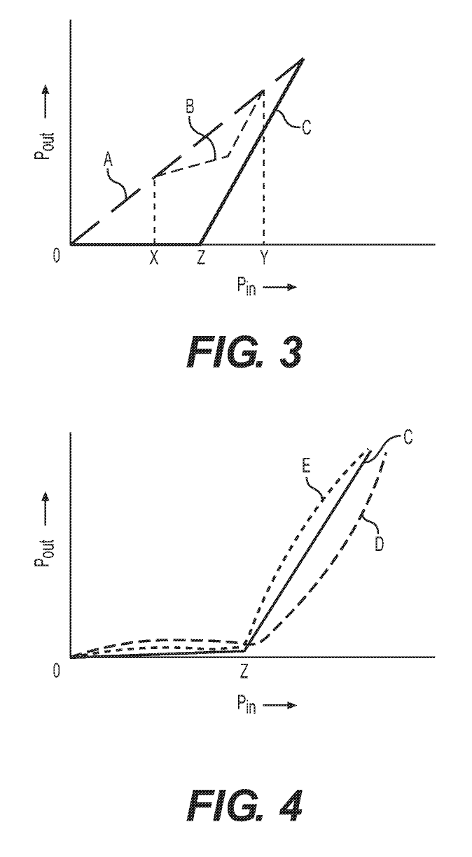

The amount of friction braking applied to the wheels 50 also varies with the brake pedal 34 position. As explained previously, the amount of friction braking applied to the wheels 50 by the air cylinders 42 is proportional to the pressure output (i.e. Pₒᵤₜ) from the proportioning valve 36. The amount of friction braking applied (Pₒᵤₜ) corresponding to different brake pedal positions is determined by the proportioning valve 36. FIG. 3 schematically illustrates the relationship between the input pressure Pᵢₙ and the output pressure Pₒᵤₜ of the proportioning valve 36. In FIG. 3, the x-axis indicates the air pressure input (Pᵢₙ) to the proportioning valve 26 and the y-axis indicates the air pressure output (Pₒᵤₜ) from the proportioning valve 36. The different curves of FIG. 3 (marked A, B, and C) indicate the relationship between Pᵢₙ and Pₒᵤₜ in different exemplary embodiments of the current disclosure.

Curve A indicates the relationship between Pᵢₙ and Pₒᵤₜ when the proportioning valve 36 is inactive or deactivated. In this case, the output pressure of the proportioning valve 36 is the same as its input pressure (i.e., Pₒᵤₜ=Pᵢₙ) at different brake pedal positions, and the slope of the curve is one (i.e., ΔPₒᵤₜ/ΔPᵢₙ=1). That is, when the proportioning valve 36 is deactivated, the amount of frictional braking applied to the bus 10 is directly proportional to Pᵢₙ or the brake pedal position. The amount of supplemental regenerative braking provided at different brake pedal positions depends on the values preprogrammed into the control system 64. The frictional braking and the regenerative braking may together provide the amount of bus retardation desired by the driver.

Curve B illustrates a typical relationship between Pᵢₙ and Pₒᵤₜ. In this typical case, the proportioning valve 36 is deactivated until Pᵢₙ=X (in any unit of pressure, such as, psi, Pa, etc.). That is, until the driver presses the brake pedal 34 by an amount sufficient to produce an input air pressure Pᵢₙ equal to X, the proportioning valve 36 remains deactivated. Between pressures X and Y, the proportioning valve 36 remains activated. Within this pressure range (i.e., X to Y), the air pressure output from the proportioning valve 36 is less than the input air pressure (i.e., Pₒᵤₜ<Pᵢₙ). The variation of Pₒᵤₜ with Pᵢₙ (or the curve profile) between X and Y may depend upon the application. In curve B, rate of increase of Pₒᵤₜ with Pᵢₙ (or the slope ΔPₒᵤₜ/ΔPᵢₙ) past pressure X first decreases and then increases until pressure Y. At Y, the proportioning valve 36 is deactivated and the rate of increase (or the slope) becomes one (since Pₒᵤₜ=Pᵢₙ). Between the brake pedal 34 positions that correspond to input pressures (Pᵢₙ) between X and Y, the amount of friction braking (or the amount of retardation provided by the friction braking system 40) is reduced. To make up for this reduction in friction braking, the control system 64 may be preprogrammed to increase the amount of regenerative braking applied to the bus 10 between these brake pedal positions. That is, when the pressure sensor 62 (FIG. 2) senses an air pressure downstream from the brake pedal 34 to be between X and Y, the control system 64 instructs the motor 22 to produce more negative torque (or regenerative braking) to account for the decrease in frictional braking. This increased regenerative braking between X and Y increases the amount of recovered energy that may be used to replenish the battery system 14.

Curve C of FIG. 3 illustrates the relationship between Pᵢₙ and Pₒᵤₜ in an embodiment of the current disclosure. In this embodiment, the proportioning valve 36 may constantly remain active, and may be configured to produce an output air pressure (Pₒᵤₜ) of substantially zero until the input air pressure (Pᵢₙ) is greater than a value Z. In this embodiment, until the brake pedal 34 is pressed beyond a point (for e.g., 20%, 40%, etc.) that produces an input air pressure Pᵢₙ of Z, the output air pressure (Pₒᵤₜ) from the proportioning valve 36, and consequently the applied friction braking to bus 10, is substantially zero. That is, until the brake pedal 34 is pressed beyond a predetermined point that causes Pᵢₙ to be greater than Z, the bus 10 is slowed substantially entirely by regenerative braking. When the input pressure Pᵢₙ becomes greater than Z (i.e., when the brake pedal is pressed past the predetermined point), Pₒᵤₜ increases and the bus 10 is slowed by both regenerative and frictional braking. The rate of increase of Pₒᵤₜ with Pᵢₙ may depend upon the application. In some embodiments (as illustrated in curve C), the rate of increase may be such that at the maximum brake pedal position, output pressure becomes equal to the input pressure (Pₒᵤₜ=Pᵢₙ). However, it is also contemplated that, in some embodiments, the output pressure becomes equal to the input pressure at a different brake pedal position.

In the embodiment of curve C, during initial slowdown of the bus 10, substantially only regenerative braking is used to slow the bus 10. The kinetic energy of the bus 10 is related to its mass (m) and speed (v) by the equation E=½mv². Therefore, the kinetic energy of the bus 10 is significantly more at higher speeds than at lower speeds. When the bus 10 is slowed using frictional braking, its kinetic energy is wasted as heat. Using substantially only regenerative braking to slow the bus 10 during its initial slowdown (i.e., when its speed is the highest) may recover the most amount of energy that may otherwise have been wasted as heat. The brake pedal 34 position until which the bus 10 is slowed substantially entirely by regenerative braking (i.e., pressure Z in FIG. 3) depends upon the application. In some embodiments, the bus 10 may be slowed substantially entirely by regenerative braking until the brake pedal position is about 10-40% of its maximum deflection (i.e., from a brake pedal position between about zero and about 10-40% of its maximum deflection). Brake pedal position of zero refers to a state when the accelerator pedal and the brake pedal of the bus 10 are not pressed. In some embodiments, the bus 10 may be slowed substantially entirely by regenerative braking until the brake pedal position is about 15-25% of its maximum deflection.

In some embodiments, a control system (regenerative braking control system 64 or another control system) may determine the brake pedal 34 position until which the bus 10 is slowed substantially entirely by regenerative braking (i.e., pressure Z) based on one or more of the amount of electric charge retained in the battery system 14, the speed of the bus 10, and the maximum amount of regenerative braking that can be provided by the motor 22. For example, if the maximum regenerative braking that can be provided by the motor 22 (or the maximum negative torque that can be applied to the motor 22) is not sufficient to provide the retardation force demanded by the driver (based, for example, on the rate of brake pedal position change) at the current speed, friction braking may begin to supplement regenerative braking earlier (i.e., Z may be closer to 0 in FIG. 3). Likewise, if the battery system 14 cannot store the recovered energy safely, friction braking may begin to supplement regenerative braking earlier (or regenerative braking may be temporarily deactivated). In a similar manner, if the motor 22 is capable of providing additional retardation force, and/or the battery system 14 is capable of storing additional energy, friction braking may begin to supplement regenerative braking at a higher pressure (i.e., Z may be moved to the right in FIG. 3).

Although the bus 10 is described as being slowed down substantially entirely by regenerative braking at Pᵢₙ≦Z (in the description of curve C above), it should be noted that in some embodiments, a small amount of frictional braking (e.g., less than about 10% of regenerative braking) may also be provided during this initial slowdown. This small amount of frictional braking may be a result of imperfections in the braking system or parasitic effects (e.g., rolling resistance, aerodynamic resistance, etc.) that slows the bus. In some embodiments, this small amount of frictional braking may be intentionally provided when Pᵢₙ≦Z to avoid an abrupt engagement of the friction braking system when Pᵢₙ>Z. Further, although Pₒᵤₜ is illustrated as varying linearly with Pᵢₙ in curve C, this is only exemplary. In general, Pₒᵤₜ may vary in any manner with Pᵢₙ. FIG. 4 illustrates Pᵢₙ versus Pₒᵤₜ curves of some exemplary embodiments in which Pₒᵤₜ exceeds zero by a small amount when Pᵢₙ≦Z, and Pₒᵤₜ varies in a non-linear manner with Pᵢₙ. Curve C of FIG. 3 is also reproduced in FIG. 4 for the sake of comparison. In curves D and E of FIG. 4, although substantially only regenerative braking is considered to slow the bus 10 during its initial slowdown (i.e., when Pᵢₙ≦Z), a small amount of friction braking is also provided (i.e., Pₒᵤₜ is slightly higher than zero). Further, in these curves, Pₒᵤₜ varies non-linearly with Pᵢₙ.

In some embodiments, the proportioning valve 36 may be hardwired (designed, etc.) to produce the Pᵢₙ versus Pₒᵤₜ curves as illustrated in FIGS. 3 and 4 and the control system 64 may be preprogrammed to provide the required regenerative braking. However, it should be noted that other variations are also contemplated. For example, in some embodiments, a control system may be configured to control both the amount of regenerative braking applied and the amount of friction braking applied to the bus 10 based, among others, on the brake pedal position. In some such embodiments, the control system may vary the output pressure Pₒᵤₜ of the proportioning valve 36 by varying the valve settings proportioning valve.

It should be noted that although the principles of the current disclosure is described with reference to a low-floor electric bus, this is only exemplary. The concepts of the current disclosure may be applied to the braking system of any electric or hybrid vehicle having a pneumatic braking system. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description. For example, while certain features have been described in connection with various embodiments, it is to be understood that any feature described in conjunction with any embodiment disclosed herein may be used with any other embodiment disclosed herein.

1. A heavy-duty electric vehicle having a pneumatic brake, comprising:
at least one electric motor configured to propel the vehicle;
a battery system configured to provide power to the at least one electric motor, the battery system configured to be recharged by regenerative braking of the vehicle;
a brake pedal; and
a braking system configured to brake the vehicle in response to actuation of the brake pedal, wherein the braking system is configured to (a) apply substantially only regenerative braking to slow the vehicle when the brake pedal position is below a threshold value, and (b) apply both regenerative braking and pneumatic braking to slow the vehicle when the brake pedal position is above the threshold value, wherein the threshold value is a percentage of a maximum brake pedal deflection.

2. The vehicle of claim 1, further including:
a proportioning valve positioned downstream of the brake pedal, wherein the brake pedal is configured to output air at a first pressure indicative of the brake pedal position to the proportioning valve, and the proportioning valve is configured to output air at a second pressure indicative of an amount of the applied pneumatic braking.

3. The vehicle of claim 2, wherein the second pressure is substantially zero for a range of brake pedal positions between about zero and the threshold value.

4. The vehicle of claim 1, wherein the threshold value is a preselected value and is between about 10-40 percent of the maximum brake pedal deflection.

5. The vehicle of claim 2, further including a regenerative braking control system configured to detect the first pressure and apply an amount of regenerative braking sufficient to account for changes in pneumatic braking caused by the proportioning valve.

6. The vehicle of claim 2, wherein the proportioning valve is a bobtail valve.

7. The vehicle of claim 1, wherein the vehicle is an electric bus.

8. A method of controlling the braking of a heavy-duty electric vehicle, comprising:
detecting a brake pedal position of the vehicle; and
controlling a braking system of the vehicle to (a) apply substantially only regenerative braking to slow the vehicle if the brake pedal position is below a threshold value, and (b) apply both regenerative braking and pneumatic braking to slow the vehicle if the brake pedal position is above the threshold value, wherein the threshold value is a percentage of a maximum brake pedal deflection.

9. The method of claim 8, wherein the braking system includes a proportioning valve configured to receive the air at the first pressure, and wherein controlling the braking system includes outputting air at a second pressure indicative of the brake pedal position from the proportioning valve.

10. The method of claim 9, wherein controlling the braking system includes outputting air at a second pressure of substantially zero when the brake pedal position is below the threshold value.

11. The method of claim 8, wherein the threshold value is a preselected value and is between about 10-40 percent of the maximum brake pedal deflection.

12. The method of claim 9, wherein controlling the braking system includes increasing an amount of regenerative braking sufficient to account for changes in pneumatic braking caused by the proportioning valve.

13. A method of slowing a heavy-duty electric bus using a combination of pneumatic braking and regenerative braking, comprising:
pressing a brake pedal of the bus from a brake pedal position of zero percent of maximum brake pedal deflection to a higher value to slow the bus;
applying substantially only regenerative braking to slow the bus during the pressing until the brake pedal is pressed to a predetermined percent of the maximum brake pedal deflection; and
applying both regenerative braking and pneumatic braking to slow the bus when the brake pedal is pressed by more than the predetermined percent.

14. The method of claim 13, wherein the predetermined percent is between about ten to forty percent of maximum brake pedal deflection.

15. The method of claim 13, wherein the predetermined percent is between about fifteen to twenty five percent of maximum brake pedal deflection.

16. The method of claim 13, further including charging a battery of the bus using energy produced by regenerative braking.

17. The method of claim 13, wherein pressing the brake pedal includes directing air at a first pressure indicative of the brake pedal position to a proportioning valve fluidly coupled to the brake pedal and positioned downstream of the brake pedal.

18. The method of claim 17, wherein pressing the brake pedal further includes outputting air at a second pressure from the proportioning valve, the second pressure being indicative of an amount of pneumatic braking applied to slow the bus.

19. The method of claim 18, wherein applying substantially only regenerative braking includes outputting air at a second pressure of substantially zero from the proportioning valve.

20. The method of claim 19, wherein applying both regenerative braking and pneumatic braking includes increasing the second pressure.
